(19) United States
(12) Patent Application Publication
(10) Pub. No.: US 2020/0393778 A1
(43) Pub. Date: Dec. 17, 2020

(54) IMAGE FORMING APPARATUS AND IMAGE FORMING METHOD

(71) Applicant: KYOCERA Document Solutions Inc., Osaka (JP)

(72) Inventors: Ayaka KUROKAWA, Osaka-shi (JP); Kiyotaka KOBAYASHI, Osaka-shi (JP)

(73) Assignee: KYOCERA Document Solutions Inc., Osaka (JP)

(21) Appl. No.: 16/899,685

(22) Filed: Jun. 12, 2020

(30) Foreign Application Priority Data
Jun. 14, 2019 (JP) 2019-111501

(51) Int. Cl. G03G 15/02; G03G 15/01

(52) U.S. Cl. CPC G03G 15/0266; G03G 15/0131; G03G 15/0225

(57) ABSTRACT

An image forming apparatus includes an image bearing member, a charger, a static eliminating section, and a determination section. The image bearing member includes a photosensitive layer. The charger charges a circumferential surface of the image bearing member. The static eliminating section eliminates static electricity from the charged circumferential surface of the image bearing member. The determination section determines whether or not static electricity is to be eliminated from the circumferential surface of the image bearing member based on a thickness of the photosensitive layer. The image forming apparatus includes a measurement section and an estimation section. The measurement section measures a drive time or the number of rotations of the image bearing member. The estimation section estimates the thickness of the photosensitive layer based on a result of measurement by the measurement section.

### INCORPORATION BY REFERENCE

The present application claims priority under 35 U.S.C. § 119 to Japanese Patent Application No. 2019-111501, filed on Jun. 14, 2019. The contents of the application are incorporated herein by reference in their entirety.

### BACKGROUND

The present disclosure relates to an image forming apparatus and an image forming method.

An image forming apparatus includes a photosensitive member, a charging roller, and a fuse lamp. The photosensitive member rotates. The fuse lamp eliminates static electricity from an upstream portion of a circumferential surface of the photosensitive member located adjacent to the surface of the charging roller. With the above configuration, image defects are prevented from occurring in printed matter.

### SUMMARY

An image forming apparatus according to an aspect of the present disclosure includes an image bearing member, a charger, a first static eliminating section, and a determination section. The image bearing member includes a photosensitive layer. The charger charges a circumferential surface of the image bearing member. The first static eliminating section eliminates static electricity from the charged circumferential surface of the image bearing member. The determination section determines, based on a thickness of the photosensitive layer, whether or not static electricity is to be eliminated from the circumferential surface of the image bearing member.

An image forming method according to a second aspect of the present disclosure includes charging, determining, and eliminating static electricity. In the charging, a circumferential surface of an image bearing member that includes a photosensitive layer is charged. In the determining, whether or not static electricity is to be eliminated from the charged circumferential surface of the image bearing member is determined based on a thickness of the photosensitive layer. In the eliminating static electricity, static electricity is eliminated from the charged circumferential surface of the image bearing member based on a result of determination in the determining.

### BRIEF DESCRIPTION OF THE DRAWINGS

FIG. 1 is a diagram illustrating a configuration of an image forming apparatus according to an embodiment of the present disclosure.

FIG. 2 is a diagram illustrating a photosensitive member and elements therearound in the embodiment.

FIG. 3 is a partial cross-sectional view of an example of the photosensitive member in the embodiment.

FIG. 4 is a partial cross-sectional view of another example of the photosensitive member in the embodiment.

FIG. 5 is a partial cross-sectional view of still another example of the photosensitive member in the embodiment.

FIG. 6 is a block diagram of the configuration of the image forming apparatus according to the embodiment.

FIG. 7 is a flowchart depicting an example of a process performed by a controller in the embodiment.

### DETAILED DESCRIPTION

The terms used in the present specification will be described first. The term “-based” may be appended to the name of a chemical compound in order to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof

### [Image Forming Apparatus]

An embodiment of the present disclosure will be described next with reference to the accompanying drawings. Note that elements that are the same or equivalent are indicated by the same reference signs in the drawings and description thereof is not repeated. In the present embodiment, an X axis, a Y axis, and a Z axis are perpendicular to one another. The X axis and the Y axis are parallel to a horizontal plane while the Z axis is parallel to a vertical line.

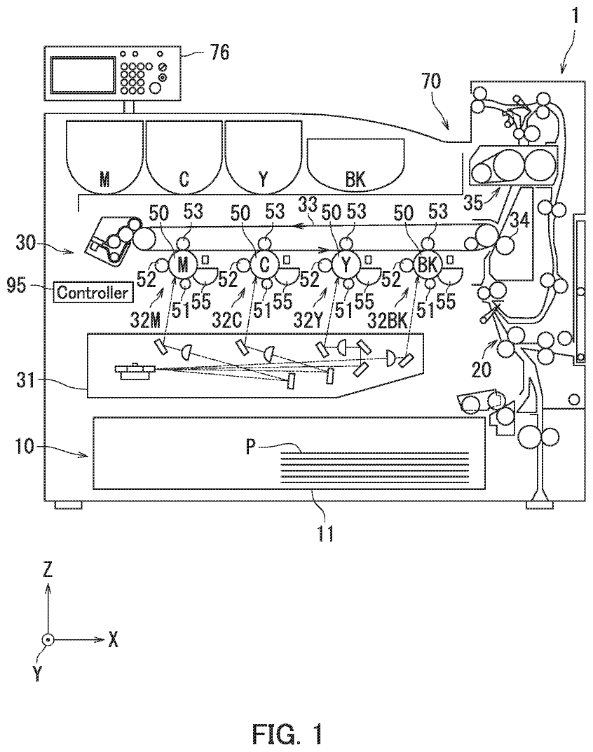

The following schematically describes an image forming apparatus 1 according to the present embodiment with reference to FIG. 1. FIG. 1 is a diagram illustrating a configuration of the image forming apparatus 1 according to the present embodiment. The image forming apparatus 1 according to the present embodiment is a full color printer. The image forming apparatus 1 includes a feeding section 10, a conveyance section 20, an image forming section 30, an ejection section 70, an operation section 76, and a controller 95.

The feeding section 10 includes a cassette 11 that accommodates a plurality of sheets P. The feeding section 10 feeds the sheets P from the cassette 11 to the conveyance section 20 one at a time. The sheets P are made from for example paper or synthetic resin. The conveyance section 20 conveys each sheet P to the image forming section 30.

The image forming section 30 includes a light exposure device 31, a magenta-color unit (also referred to below as an M unit) 32M, a cyan-color unit (also referred to below as a C unit) 32C, a yellow-color unit (also referred to below as a Y unit) 32Y, a black-color unit (also referred to below as a BK unit) 32BK, a transfer belt 33, a secondary transfer roller 34, and a fixing device 35. The M unit 32M, the C unit 32C, the Y unit 32Y, and the BK unit 32BK each include a photosensitive member 50, a charger 51, a development roller 52, a primary transfer roller 53, and a cleaner 55.

The light exposure device 31 irradiates each of the M unit 32M, the C unit 32C, the Y unit 32Y, and the BK unit 32BK with light based on image data to form respective electrostatic latent images on the M unit 32M, the C unit 32C, the Y unit 32Y, and the BK unit 32BK. The M unit 32M forms a toner image in a magenta color from the electrostatic latent image formed thereon. The C unit 32C forms a toner image in a cyan color from the electrostatic latent image formed thereon. The Y unit 32Y forms a toner image in a yellow color from the electrostatic latent image formed thereon. The BK unit 32BK forms a toner image in a black color from the electrostatic latent image formed thereon.

Each photosensitive member 50 has a drum shape. The photosensitive member 50 rotates about a rotational center thereof. The charger 51, the development roller 52, the primary transfer roller 53, and the cleaner 55 are arranged around the photosensitive member 50 in the stated order from upstream in a rotational direction of the photosensitive member 50. The charger 51 positively charges a circumferential surface of the photosensitive member 50. For example, the charger 51 charges the circumferential surface of the photosensitive member 50 to a potential of 500 V.

As described above, the light exposure device 31 exposes the charged circumferential surface of the photosensitive member 50 with light to form an electrostatic latent image on the circumferential surface of the photosensitive member 50. The light emitted from the light exposure device 31 has a wavelength of for example 780 nm. The light exposure device 31 has an exposure dose of for example 1 μl/m².

The development roller 52 develops the electrostatic latent image into a toner image by supplying toner to the electrostatic latent image. Thus, the toner image is formed on the circumferential surface of the photosensitive member 50. The toner image contains toner.

The transfer belt 33 is in contact with the circumferential surfaces of the photosensitive members 50. The primary transfer rollers 53 primarily transfer the toner images formed on the circumferential surfaces of the respective photosensitive members 50 to the transfer belt 33 (specifically, an outer surface of the transfer belt 33). Toner images in four different colors are primarily transferred onto the outer surface of the transfer belt 33 in a superimposed manner. The toner images in the four colors include a magenta toner image, a cyan toner image, a yellow toner image, and a black toner image. Through primary transfer as above, a color toner image is formed on the outer surface of the transfer belt 33. The secondary transfer roller 34 secondarily transfers the color toner image formed on the outer surface of the transfer belt 33 to the sheet P. The fixing device 35 fixes the color toner image to the sheet P by applying heat and pressure to the sheet P. The sheet P with the color toner image fixed thereto is ejected onto the ejection section 70. After primary transfer, the cleaners 55 collect toner remaining on the circumferential surfaces of the respective photosensitive members 50.

The controller 95 includes a processor such as a central processing unit (CPU).

The operation section 76 receives various operations from a user. For example, the operation section 76 receives a print job. Specifically, the operation section 76 includes a display section and an operation key section.

Note that each photosensitive member 50 corresponds to an “image bearing member”. Each development roller 52 corresponds to a “developing section”. Each primary transfer roller 53 corresponds to a “transfer section”. The transfer belt 33 corresponds to a “transfer target”. Each cleaner 55 corresponds to a“cleaning section”. The light exposure device 31 corresponds to a “light exposure section”.

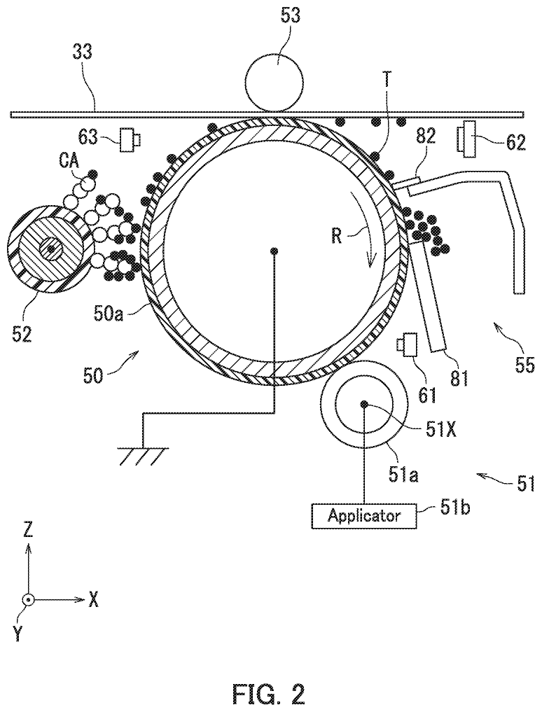

The image forming apparatus 1 according to the present embodiment will be further described next with reference to FIG. 2. FIG. 2 is a diagram illustrating the photosensitive member 50 and the vicinity thereof. As illustrated in FIG. 2, each unit 32M, 32C. 32Y, and 32BK of the image forming apparatus 1 further includes a first static eliminating section 61, a second static eliminating section 62, and a third static eliminating section 63 in addition to the charger 51, the development roller 52, the primary transfer roller 53, and the cleaner 55.

### <Development Roller>

Each development roller 52 carries toner T by attracting carrier CA carrying the toner T by magnetic force thereof. Application of developing bias (developing voltage) to the development roller 52 generates potential difference between the development roller 52 and a circumferential surface 50a of a corresponding photosensitive member 50 with a result that the toner T moves to an electrostatic latent image formed on the circumferential surface 50a of the photosensitive member 50 so as to be attached thereto.

### <Charger>

Each charger 51 includes a charging roller 51a and an applicator 51b. The charging roller 51a has a drum shape. The charging roller 51a rotates about a rotational axis 51X thereof. The charging roller 51a has a surface arranged to be in contact with the circumferential surface 50a of the photosensitive member 50. Note that the charging roller 51a corresponds to a charger.

The applicator 51b applies charging voltage (charging bias) to the charging roller 51a The applicator 51b is controlled by the controller 95. Specifically, the applicator 5b is controlled by the controller 95 so as to apply charging voltage (charging bias) at a specific value to the charging roller 51a. The charging voltage (charging bias) is a direct current voltage. The amount of electrical discharge from the charging roller 51a to the photosensitive member 50 can be smaller and the abrasion amount of the circumferential surface 50a of the photosensitive member 50 can be smaller in a configuration in which the charging voltage is a direct current voltage than in a configuration in which the charging voltage is a composite voltage obtained by superimposing a direct current voltage on an alternating current voltage.

### <Primary Transfer Roller>

In primary transfer, transfer voltage (transfer bias) is applied to each of the primary transfer rollers 53 to charge the primary transfer roller 53. A potential difference (transfer fields) between the surface potential of the circumferential surfaces 50a of the photosensitive members 50 and the surface potential of the primary transfer rollers 53 causes primary transfer of the toner images carried on the circumferential surfaces 50a of the respective photosensitive members 50 to the outer surface of the circulating transfer belt 33.

### <Cleaner>

Each cleaner 55 includes a cleaning blade 81 and a toner seal 82. The cleaning blade 81 is located downstream of a corresponding primary transfer roller 53 in a rotational direction R of a corresponding photosensitive member 50. The cleaning blade 81 is pressed against the circumferential surface 50a of the photosensitive member 50 and collects residual toner T on the circumferential surface 50a of the photosensitive member 50. The residual toner T refers to the toner T remaining on the circumferential surface 50a of the photosensitive member 50 after primary transfer. Specifically, a distal end of the cleaning blade 81 is pressed against the circumferential surface 50a of the photosensitive member 50, and a direction from a proximal end to the distal end of the cleaning blade 81 is opposite to the rotational direction R at a point of contact between the distal end of the cleaning blade 81 and the circumferential surface 50a of the photosensitive member 50. The cleaning blade 81 is in so-called counter contact with the circumferential surface 50a of the photosensitive member 50. Thus, the cleaning blade 81 is tightly pressed against the circumferential surface 50a of the photosensitive member 50 such that the cleaning blade 81 digs into the photosensitive member 50 as the photosensitive member 50 rotates. Insufficient cleaning can be further prevented through the cleaning blade 81 being tightly pressed against the circumferential surface 50a of the photosensitive member 50. The cleaning blade 81 is for example an elastic plate-shaped member. More specifically, the cleaning blade 81 is a rubber plate-shaped member. The cleaning blade 81 is in line-contact with the circumferential surface 50a of the photosensitive member 50.

### <First Static Eliminating Section>

Each first static eliminating section 61 eliminates static electricity from the charged circumferential surface 50a of a corresponding photosensitive member 50. Specifically, the first static eliminating section 61 irradiates an irradiation surface portion of the photosensitive member 50 with light to eliminate static electricity on the irradiation surface portion. The irradiation surface portion of the photosensitive member 50 is located on an upstream side of a site in the rotational direction R. The site is a site where the charging roller 51a charges the circumferential surface 50a of the photosensitive member 50. More specifically, the irradiation surface portion of the photosensitive member 50 is located on an upstream side of a contact plane in the rotational direction R. The contact plane is a contact plane where the circumferential surface 50a of the photosensitive member 50 is in contact with the surface of the charging roller 51a. The first static eliminating section 61 is disposed downstream of the cleaner 55 in terms of the rotational direction R of the photosensitive member 50. That is, the first static eliminating section 61 eliminates static electricity from a site located on an upstream side of a site in the rotational direction R. The site is a site where the charger 51 charges the circumferential surface 50a of the photosensitive member 50 and on a downstream of a site in the rotational direction R. The site is a site where the cleaner 55 collects residual toner on the circumferential surface 50a of the photosensitive member 50. In other words, the first static eliminating section 61 eliminates static electricity from a site between a corresponding charger 51 and a corresponding cleaner 55. The first static eliminating section 61 is for example a static elimination lamp.

Each first static eliminating section 61 is controlled by the controller 95. Specifically, each first static eliminating section 61 emits light upon receiving an on signal from the controller 95. By contrast, the first static eliminating section 61 does not emit light while the on signal is not being received from the controller 95.

The light emitted from the first static eliminating section 61 preferably has a wavelength of 680 nm or longer and 880 nm or shorter. The static elimination light intensity of the first static eliminating section 61 is preferably at least 0 μJ/cm² and no greater than 4 μJ/cm², and more preferably at least 0 μJ/cm² and no greater than 2 μJ/cm². Note that the static elimination light intensity of the first static eliminating section 61 being 0 μJ/cm² means that static electricity is not eliminated from the circumferential surface 50a of the photosensitive member 50 by the first static eliminating section 61.

The static elimination light intensity means a light quantity of light reaching the circumferential surface 50a of the photosensitive member 50. Specifically, the light quantity of light reaching the circumferential surface 50a of the photosensitive member 50 was measured using an optical power meter (“OPTICAL POWER METER 3664”, product of HIOKI E.E. CORPORATION).

### <Second Static Eliminating Section>

Each second static eliminating section 62 eliminates static electricity from the circumferential surface 50a of a corresponding photosensitive member 50 after transfer by a corresponding primary transfer roller 53. Specifically, a period between a timing when the second static eliminating section 62 eliminates static electricity from the circumferential surface 50a of the photosensitive member 50 and a timing when a corresponding charger 51 charges is 20 ms or longer, preferably 50 ms or longer. Specifically, the second static eliminating section 62 is disposed on a downstream side of the primary transfer roller 53 and an upstream side of a corresponding cleaner 55 in the rotational direction R of the photosensitive member 50. The second static eliminating section 62 is a static elimination lamp, for example.

Each second static eliminating section 62 is controlled by the controller 95. Specifically, when the operation section 76 receives a print job, the controller 95 outputs the on signal to each second static eliminating section 62 to cause the second static eliminating section 62 to emit light.

The light emitted from the second static eliminating section 62 preferably has a wavelength of 680 nm or longer and 880 nm or shorter, and more preferably has a wavelength longer than that of the light emitted from the first static eliminating section 61.

The static elimination light intensity of the second static eliminating section 62 is preferably at least 0 μJ/cm² and no greater than 10 μJ/cm², and more preferably at least 0 μJ/cm² and no greater than 5 μJ/cm². As a result of the static elimination light intensity of the second static eliminating section 62 being no greater than 10 μJ/cm², an amount of charge trapped in the photosensitive member 50 decreases to enable an increase in chargeability of the photosensitive member 50. Furthermore, the static elimination light intensity of the second static eliminating section 62 is preferably equal to or greater than the static elimination light intensity of the first static eliminating section 61. Note that the static elimination light intensity of the second static eliminating section 62 being 0 μJ/cm² means that static electricity is not eliminated from the photosensitive member 50 by the second static eliminating section 62. Alternatively, it means that the image formation apparatus adopts no static elimination system.

### <Third Static Eliminating Section>

Each third static eliminating section 63 eliminates static electricity from the circumferential surface 50a of a corresponding photosensitive member 50 after charging by a corresponding charger 51 and before transfer by a corresponding primary transfer roller 53. Specifically, a period between a timing when the third static eliminating section 63 eliminates static electricity from the circumferential surface 50a of the photosensitive member 50 and the timing when the corresponding charger 51 charges is 20 ms or longer, preferably 50 ms or longer. Specifically, the third static eliminating section 63 is disposed on a downstream side of a corresponding development roller 52 and on an upstream side of the primary transfer roller 53 in the rotational direction R of the photosensitive member 50. The third static eliminating section 63 is for example a static elimination lamp.

Each third static eliminating section 63 is controlled by the controller 95. Specifically, when the operation section 76 receives a print job, the controller 95 outputs the on signal to each third static eliminating section 63 to cause the third static eliminating section 63 to emit light.

The light emitted from the third static eliminating section 63 preferably has a wavelength of 680 nm or longer and 880 nm or shorter, and more preferably has a wavelength longer than that of the light emitted from the first static eliminating section 61.

The static elimination light intensity of the third static eliminating section 63 is preferably at least 0 J/cm² and no greater than 10 μJ/cm², and more preferably at least 0 μJ/cm² and no greater than 5 μJ/cm². As a result of the static elimination light intensity of the third static eliminating section 63 being no greater than 10 μJ/cm², an amount of charge trapped in the photosensitive member 50 decreases to enable an increase in chargeability of the photosensitive member 50. Furthermore, the static elimination light intensity of the third static eliminating section 63 is preferably equal to or smaller than the static elimination light intensity of the first static eliminating section 61. Note that the static elimination light intensity of the third static eliminating section 63 being 0 μJ/cm² means that static electricity is not eliminated from the photosensitive member 50 by the third static eliminating section 63.

### <Photosensitive Member>

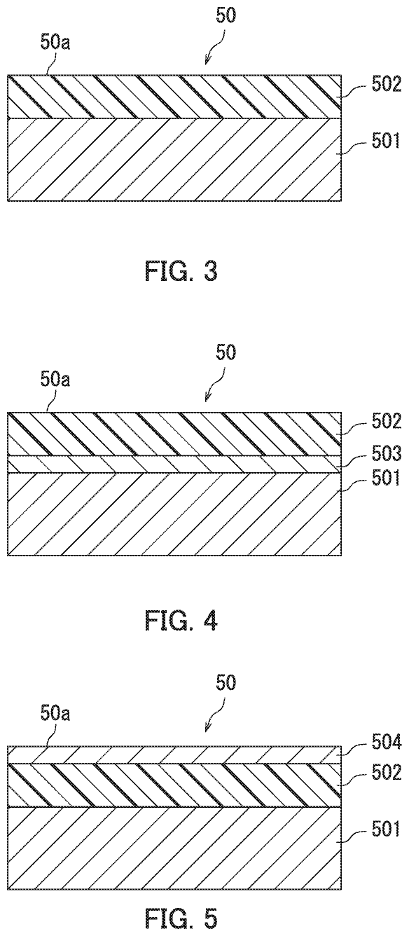

The following describes a photosensitive member 50 included in the image forming apparatus 1 with reference to FIGS. 3 to 5. FIG. 3 is a partial cross-sectional view of an example of the photosensitive member 50. FIG. 4 is a partial cross-sectional view of another example of the photosensitive member 50. FIG. 5 is a partial cross-sectional view of still another example of the photosensitive member 50. The photosensitive member 50 is for example an organic photoconductor (OPC) drum.

As illustrated in FIG. 3, the photosensitive member 50 includes for example a conductive substrate 501 and a photosensitive layer 502. The photosensitive layer 502 is a single layer (one layer). The photosensitive member 50 is a single-layer electrophotographic photosensitive member including the photosensitive layer 502 of a single layer. The photosensitive layer 502 contains a charge generating material, a hole transport material, an electron transport material, and a binder resin. Although not limited particularly, the film thickness of the photosensitive layer 502 is preferably at least 5 μm and no greater than 100 μm, and more preferably at least 15 μm and no greater than 35 μm. The film thickness of the photosensitive layer 502 corresponds to a thickness of the photosensitive layer 502.

As illustrated in FIG. 4, the photosensitive member 50 may include a conductive substrate 501, a photosensitive layer 502, and an intermediate layer 503 (undercoat layer). The intermediate layer 503 is disposed between the conductive substrate 501 and the photosensitive layer 502. As illustrated in FIG. 3, the photosensitive layer 502 may be disposed directly on the conductive substrate 501. Alternatively, the photosensitive layer 502 may be disposed on the conductive substrate 501 with the intermediate layer 503 therebetween as illustrated in FIG. 4. The intermediate layer 503 may be a single-layer intermediate layer or a multi-layer intermediate layer.

As illustrated in FIG. 5, the photosensitive member 50 may include a conductive substrate 501, a photosensitive layer 502, and a protective layer 504. The protective layer 504 is disposed on the photosensitive layer 502. The protective layer 504 may be a single-layer protective layer or a multi-layer protective layer.

### (Chargeability Ratio)

A ghost image is likely to occur particularly when the charging roller 51a is located in contact with the circumferential surface 50a of the photosensitive member 50 and the charging voltage is a direct current voltage. The ghost image is an image reappearing on printed matter as a residual image of an image formed during a previous rotation of the photosensitive member 50. However, when the photosensitive member 50 satisfies expression (1) shown below, production of a ghost image can be inhibited even in a configuration in which the surface of the charging roller 51a is arranged in contact with the circumferential surface 50a of the photosensitive member 50 and the charging voltage is a direct current voltage.

$$0.60 ≦ \frac{V}{( Q / S ) \times ( d / {ɛ}_{r} \cdot {ɛ}_{0} )} \qquad ( 1 )$$

In expression (1), Q represents a charge amount (unit: C) of the charged circumferential surface 50a of the photosensitive member 50. S represents an area (unit: m²) of the charged circumferential surface 50a of the photosensitive member 50. d represents a film thickness (unit: m) of the photosensitive layer 502 of the photosensitive member 50. εᵣ represents a specific permittivity of a binder resin contained in the photosensitive layer 502 of the photosensitive member 50. ε₀ represents a vacuum permittivity (unit: F/m). Note that “d/εᵣ-ε₀” means d/(εᵣ×ε₀)”. V is a value calculated in accordance with expression (2) shown below.

V=V₀−Vᵣ (2)

Vᵣ in expression (2) represents a first potential of the circumferential surface 50a of the photosensitive member 50 yet to be charged by the charging roller 51a. V₀ in expression (2) represents a second potential of the circumferential surface 50a of the photosensitive member 50 charged by the charging roller 51a.

In the following description, a value expressed by the following expression (1′) in expression (1) may be also referred to below as a chargeability ratio. The chargeability ratio expressed by expression (1′) is a ratio of an actual chargeability (measured value) of the photosensitive member 50 to a theoretical chargeability (theoretical value) of the photosensitive member 50 when the circumferential surface 50a of the photosensitive member 50 is charged by the charging roller 51a.

$$\frac{V}{( Q / S ) \times ( d / {ɛ}_{r} \cdot {ɛ}_{0} )} \qquad ( {1}^{′} )$$

The photosensitive layer 502 contains a charge generating material, a hole transport material, an electron transport material, and a binder resin. The photosensitive layer 502 may further contain an additive as needed. The following describes the charge generating material, the hole transport material, the electron transport material, the binder resin, the additive, and a preferable combination of the materials.

### (Charge Generating Material)

No particular limitations are placed on the charge generating material. Examples of the charge generating material include phthalocyanine-based pigments, perylene-based pigments, bisazo pigments, tris-azo pigments, dithioketopyrrolopyrrole pigments, metal-free naphthalocyanine pigments, metal naphthalocyanine pigments, squaraine pigments, indigo pigments, azulenium pigments, cyanine pigments, powders of inorganic photoconductive materials (for example, selenium, selenium-tellurium, selenium-arsenic, cadmium sulfide, and amorphous silicon), pyrylium pigments, anthanthrone-based pigments, triphenylmethane-based pigments, threne-based pigments, toluidine-based pigments, pyrazoline-based pigments, and quinacridon-based pigments. The photosensitive layer 502 may contain only one charge generating material or contain two or more charge generating materials.

Preferable examples of the phthalocyanine-based pigments that can contribute to inhibition of production of a ghost image include metal-free phthalocyanine, titanyl phthalocyanine, and chloroindium phthalocyanine. Of the phthalocyanine-based pigments listed above, titanyl phthalocyanine is more preferable.

The content percentage of the charge generating material is preferably greater than 0.0% by mass and no greater than 1.0% by mass relative to mass of the photosensitive layer 502, and more preferably greater than 0.0% by mass and no greater than 0.5% by mass. As a result of the content percentage of the charge generating material being no greater than 1.0% by mass relative to the mass of the photosensitive layer 502, chargeability ratio can be increased. The mass of the photosensitive layer 502 is total mass of materials contained in the photosensitive layer 502. In a case where the photosensitive layer 502 contains a charge generating material, a hole transport material, an electron transport material, and a binder resin, the mass of the photosensitive layer 502 is a total of mass of the charge generating material, mass of the hole transport material, mass of the electron transport material, and mass of the binder resin. In a case where the photosensitive layer 502 contains a charge generating material, a hole transport material, an electron transport material, a binder resin, and an additive, the mass of the photosensitive layer 502 is a total of the mass of the charge generating material, the mass of the hole transport material, the mass of the electron transport material, the mass of the binder resin, and the mass of the additive.

### (Hole Transport Material)

No particular limitations are placed on the hole transport material. Examples of the hole transport material include nitrogen-containing cyclic compounds and condensed polycyclic compounds. Examples of the nitrogen containing cyclic compounds and the condensed polycyclic compounds include: triphenylamine derivatives; diamine derivatives (specific examples include an N,N,N′,N′-tetraphenylbenzidine derivative, an N,N,N′,N′-tetraphenylphenylenediamine derivative, an N,N,N′,N′-tetraphenylnaphtylenediamine derivative, a di(aminophenylethenyl)benzene derivative, and an N,N,N′,N′-tetraphenylphenanthrylenediamine derivative); oxadiazole-based compounds (specific examples 2,5-di(4-methylaminophenyl)-1,3,4-oxadiazole); styryl-based compounds (specific examples include 9-(4-diethylaminostyryl)anthracene); carbazole-based compounds (specific examples include polyvinyl carbazole); organic polysilane compounds; pyrazoline-based compounds (specific examples include 1-phenyl-3-(p-dimethylaminophenyl)pyrazoline); hydrazone-based compounds; indole-based compounds; oxazole-based compounds; isoxazole-based compounds; thiazole-based compounds; thiadiazole-based compounds; imidazole-based compounds; pyrazole-based compounds; and tiazole-based compounds. The photosensitive layer 502 may contain only one hole transport material or may contain two or more hole transport materials.

The content percentage of the hole transport material is preferably greater than 0.0% by mass and no greater than 35.0% by mass relative to the mass of the photosensitive layer 502, and more preferably at least 10.0% by mass and no greater than 30.0% by mass.

### (Binder Resin)

Examples of the binder resin include thermoplastic resins, thermosetting resins, and photocurable resins. Examples of the thermoplastic resins include polycarbonate resins, polyarylate resins, styrene-butadiene copolymers, styrene-acrylonitrile copolymers, styrene-maleic acid copolymers, acrylic acid polymers, styrene-acrylic acid copolymers, polyethylene resins, ethylene-vinyl acetate copolymers, chlorinated polyethylene resins, polyvinyl chloride resins, polypropylene resins, ionomer resins, vinyl chloride-vinyl acetate copolymers, alkyd resins, polyamide resins, urethane resins, polysulfone resins, diallyl phthalate resins, ketone resins, polyvinyl butyral resins, polyester resins, and polyether resins. Examples of the thermosetting resins include silicone resins, epoxy resins, phenolic resins, urea resins, and melamine resins. Examples of the photocurable resins include acrylic acid adducts of epoxy compounds, and acrylic acid adducts of urethane compounds. The photosensitive layer 502 may contain only one binder resin or may contain two or more binder resins.

The binder resin preferably has a viscosity average molecular weight of at least 10,000, more preferably at least 20,000, still more preferably at least 30.000, further preferably at least 50,000, and particularly preferably at least 55,000. As a result of the binder resin having a viscosity average molecular weight of at least 10.000, abrasion resistance of the photosensitive member 50 tends to increase. The viscosity average molecular weight of the binder resin is preferably no greater than 80,000, and more preferably no greater than 70,000. As a result of the viscosity average molecular weight of the binder resin being no greater than 80,000, the binder resin tends to readily dissolve in a solvent for photosensitive layer formation, facilitating formation of the photosensitive layer 502.

The content percentage of the binder resin is preferably at least 30.0% by mass and no greater than 70.0% by mass relative to the mass of the photosensitive layer 502, and more preferably at least 40.0% by mass and no greater than 60.0% by mass.

### (Electron Transport Material)

Examples of the electron transport material include quinone-based compounds, diimide-based compounds, hydrazone-based compounds, malononitrile-based compounds, thiopyran-based compounds, trinitrothioxanthone-based compounds, 3,4,5,7-tetranitro-9-fluorenone-based compounds, dinitroanthracene-based compounds, dinitroacridine-based compounds, tetracyanoethylene, 2,4,8-trinitrothioxanthone, dinitrobenzene, dinitroacridine, succinic anhydride, maleic anhydride, and dibromomaleic anhydride. Examples of the quinone-based compounds include diphenoquinone-based compounds, azoquinone-based compounds, anthraquinone-based compounds, naphthoquinone-based compounds, nitroanthraquinone-based compounds, and dinitroanthraquinone-based compounds. The photosensitive layer 502 may contain only one electron transport material or contain two or more electron transport materials.

The content percentage of the electron transport material is preferably at least 5.0% by mass and no greater than 50.0% by mass relative to the mass of the photosensitive layer 502, and more preferably at least 20.0% by mass and no greater than 30.0% by mass. In the case of the photosensitive layer 502 containing two or more electron transport materials, the content percentage of the electron transport material refers to a total content percentage of the two or more electron transport materials.

### (Additive)

The photosensitive layer 502 may further contain an additive as necessary. Examples of the additive include antidegradants (specific examples include antioxidants, radical scavengers, quenchers, and ultraviolet absorbing agents), softeners, surface modifiers, extenders, thickeners, dispersion stabilizers, waxes, donors, surfactants, and leveling agents. In a case where the photosensitive layer 502 contains an additive, the photosensitive layer 502 may contain only one additive or contain two or more additives.

### (Intermediate Layer)

The intermediate layer 503 for example contains inorganic particles and a resin for use in the intermediate layer 503 (intermediate layer resin). Provision of the intermediate layer 503 may facilitate flow of current generated when the photosensitive member 50 is exposed to light and inhibit resistance from increasing, while also maintaining insulation to a sufficient degree so as to inhibit current leakage from occurring.

Examples of the inorganic particles include particles of metals (specific examples include aluminum, iron, and copper), particles of metal oxides (specific examples include titanium oxide, alumina, zirconium oxide, tin oxide, and zinc oxide), and particles of non-metal oxides (specific examples include silica). Any one type of the inorganic particles listed above may be used independently, or any two or more types of the inorganic particles listed above may be used in combination. Note that the inorganic particles may be surface-treated. No particular limitations are placed on the intermediate layer resin other than being a resin that can be used to form the intermediate layer 503.

### <Storage>

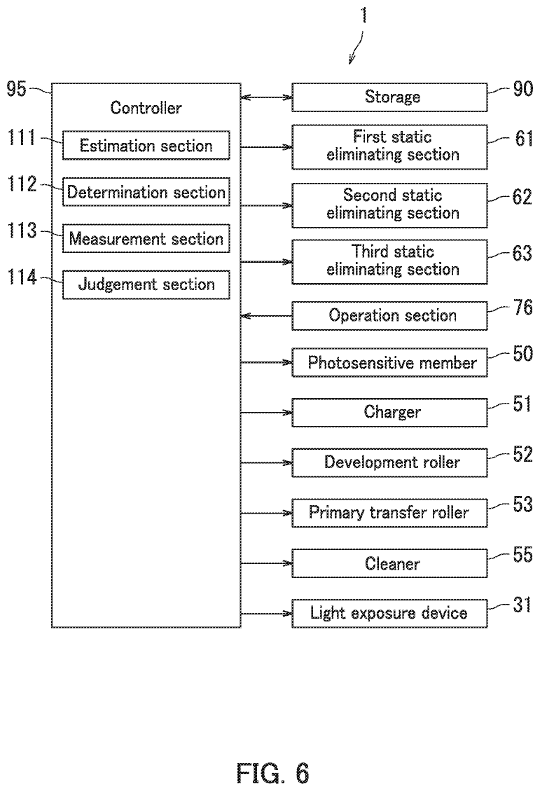

The configuration of the image forming apparatus 1 will be described next with reference to FIG. 6. FIG. 6 is a block diagram of the configuration of the image forming apparatus 1. As illustrated in FIG. 6, the image forming apparatus 1 further includes storage 90.

The storage 90 includes a storage device, and stores computer programs therein. Specifically, the storage 90 includes a main storage device such as semiconductor memory, and an auxiliary storage device. The auxiliary storage device includes for example at least one of semiconductor memory and a hard disk drive.

Specifically, the storage 90 stores therein Table 1 shown below. Table 1 shows a relationship among surface potential of the photosensitive member 50, film thickness of the photosensitive layer 502, and occurrence of charge irregularity in a situation in which the first static eliminating section 61 does not eliminate static electricity from the photosensitive member 50. The photosensitive member 50 may be for example a first photosensitive member 50 shown in Table 1. Alternatively, the photosensitive member 50 may be for example a second photosensitive member 50 shown in Table 1.

The first photosensitive member 50 shown in Table 1 includes a conductive substrate 501 and a photosensitive layer 502 as illustrated in FIG. 3. The first photosensitive member 50 satisfies expression (1). Similarly, the second photosensitive member 50 includes a conductive substrate 501 and a photosensitive layer 502 as illustrated in FIG. 3. However, the second photosensitive member 50 does not satisfy expression (1). Charging irregularity is likely to occur in the photosensitive member 50 that satisfies expression (1). Charging irregularity is for example a phenomenon by which spots of voids are visualized for example in printed matter with a solid image printed thereon.

TABLE 1

| Surface potential | | First photosensitive | Second photosensitive |
|---|---|---|---|
| 500 [V] | | member | member |
| Photosensitive | 15 | Not occurred | Not occurred |
| layer film | 20 | Not occurred | Not occurred |
| thickness [μm] | 25 | Occurred | Not occurred |
| | 30 | Occurred | Not occurred |
| | 35 | Occurred | Occurred |

The surface potential of the charging roller 51a is 500 V in Table 1. In Table 1, rows indicate film thickness of the photosensitive layer 502 while columns indicate types of the photosensitive member 50. In Table 1, “Not occurred” indicates no occurrence of charging irregularity while “Occurred” indicates occurrence of charging irregularity. Note that Table 1 shows results of evaluation as to whether or not charging irregularity has occurred in the image forming apparatus 1 installed in an environment with a temperature of 32.5° C. and a relative humidity of 80%.

As shown in Table 1, charging irregularity occurs in the first photosensitive member 50 that includes the photosensitive layer 502 of which film thickness is 25 μm to 35 μm. By contrast, no charging irregularity occurs in the first photosensitive member 50 that includes the photosensitive layer 502 of which film thickness is 15 μm to 20 μm. Charging irregularity occurs in the second photosensitive member 50 that includes the photosensitive layer 502 of which film thickness is 35 μm. By contrast, no charging irregularity occurs in the second photosensitive member 50 that includes the photosensitive layer 502 of which film thickness is 15 μm to 30 μm.

Through image formation, the photosensitive layer 502 is abraded by the cleaner 55, thereby reducing the film thickness of the photosensitive layer 502. For example, the film thickness of the photosensitive layer 502 is 35 μm at shipment. Further, the film thickness of the photosensitive layer 502 having been abraded by the cleaner 55 is 15 μm. The thinner the film thickness of the photosensitive layer 502 is, the less charging irregularity occurs. As such, charging irregularity occurs in the first photosensitive member 50 when the film thickness of the photosensitive layer 502 is 35 μm while no charging irregularity occurs in the first photosensitive member 50 when the film thickness of the photosensitive layer 502 becomes 20 μm. Further, charging irregularity occurs in the second photosensitive member 50 when the film thickness of the photosensitive layer 502 is 35 μm while no charging irregularity occurs in the second photosensitive member 50 when the film thickness of the photosensitive layer 502 becomes 30 μm.

Occurrence of charging irregularity can be inhibited by the first static eliminating section 61 eliminating static electricity from the circumferential surface 50a of the photosensitive member 50 in the present embodiment. When the photosensitive member 50 satisfies expression (1), occurrence of charging irregularity and production of a ghost image can be inhibited by the first static eliminating section 61 eliminating static electricity from the circumferential surface 50a of the photosensitive member 50.

As illustrated in FIG. 6, the controller 95 includes a determination section 112. The processor of the controller 95 functions as the determination section 112 by executing a computer program stored in the storage device of the storage 90.

The determination section 112 determines, based on the film thickness of the photosensitive layer 502, whether or not static electricity is to be eliminated from the circumferential surface 50a of the photosensitive member 50. When the film thickness of the photosensitive layer 502 is a film thickness at which charging irregularity occurs, the determination section 112 determines that static electricity is to be eliminated from the circumferential surface 50a of the photosensitive member 50. By contrast, when the film thickness of the photosensitive layer 502 is a film thickness at which charging irregularity does not occur, the determination section 112 determines that static electricity is not to be eliminated from the circumferential surface 50a of the photosensitive member 50. Accordingly, a situation in which the photosensitive layer 502 is always irradiated by the first static eliminating section 61 can be prevented. As a result, occurrence of charging irregularity can be inhibited while reducing degradation of the circumferential surface 50a of the photosensitive member 50.

For example, charging irregularity occurs in the first photosensitive member 50 in Table 1 that includes the photosensitive layer 502 of which film thickness is 35 μm. The determination section 112 accordingly determines that static electricity is to be eliminated from the circumferential surface 50a of the first photosensitive member 50. Specifically, the determination section 112 outputs the on signal to the first static eliminating section 61 when the film thickness of the photosensitive layer 502 of the first photosensitive member 50 is 35 μm. Once the film thickness of the photosensitive layer 502 becomes 20 μm as a result of repetitive image formation and cleaning, charging irregularity does not occur even without elimination of static electricity from the circumferential surface 50a of the first photosensitive member 50 by the first static eliminating section 61 as shown in Table 1. The determination section 112 accordingly determines that static electricity is not to be eliminated from the circumferential surface 50a of the first photosensitive member 50. That is, the first static eliminating section 61 is controlled based on the film thickness of the photosensitive layer 502 with a result that static electricity can be eliminated from the circumferential surface 50a of the photosensitive member 50 only when necessary. Consequently, occurrence of charging irregularity on printed matter can be reduced while degradation of the circumferential surface 50a of the photosensitive member 50 can be reduced.

For example, charging irregularity occurs in the second photosensitive member 50 in Table 1 that includes the photosensitive layer 502 of which film thickness is 35 μm. The determination section 112 accordingly outputs the on signal to the first static eliminating section 61 when the film thickness of the photosensitive layer 502 of the second photosensitive member 50 is 35 μm. Once the film thickness of the photosensitive layer 502 becomes 30 μm as a result of repetitive image formation and cleaning, charging irregularity does not occur even without elimination of static electricity from the circumferential surface 50a of the second photosensitive member 50 by the first static eliminating section 61 as shown in Table 1. The determination section 112 accordingly determines that static electricity is not to be eliminated from the circumferential surface 50a of the second photosensitive member 50. That is, the first static eliminating section 61 is controlled based on the film thickness of the photosensitive layer 502 with a result that static electricity can be eliminated from the circumferential surface 50a of the photosensitive member 50 only when necessary. Consequently, occurrence of charging irregularity on printed matter can be reduced while degradation of the circumferential surface 50a of the photosensitive member 50 can be reduced.

Furthermore, in a configuration including the cleaner 55, degradation of the circumferential surface 50a of the photosensitive member 50 can be reduced. This can result in reduction in abrasion amount of the circumferential surface 50a of the photosensitive member 50 even if the circumferential surface 50a of the photosensitive member 50 is pressed in hard contact with the cleaner 55.

When the photosensitive member 50 satisfies expression (1), production of a ghost image can be inhibited.

The configuration of the controller 95 will be described further in detail with further reference to FIG. 6. As illustrated in FIG. 6, the controller 95 further includes an estimation section 111 and a measurement section 113. The processor of the controller 95 functions as the estimation section 111 and the measurement section 113 through execution of the computer programs stored in the storage device of the storage 90.

The measurement section 113 measures a total drive time or a total number of rotations of the photosensitive member 50 from a start of use of the image forming apparatus 1. Alternatively, the measurement section 113 may measure a total drive time of the photosensitive member 50 from a start of use of the photosensitive member 50 or a total number of rotations of the photosensitive member 50 from a start of use of the photosensitive member 50.

The estimation section 111 estimates a film thickness of the photosensitive layer 502. Specifically, the estimation section 111 estimates a film thickness of the photosensitive layer 502 based on a result of measurement by the measurement section 113. The estimation section 111 is capable of estimating an abrasion amount of the photosensitive layer 502 abraded by the cleaning blade 81 based on a result of measurement by the measurement section 113. Therefore, the estimation section 111 can estimate a film thickness of the photosensitive layer 502 based on the abrasion amount. In the above configuration, the estimation section 111 can accurately estimate a film thickness of the photosensitive layer 502.

The abrasion amount of the photosensitive layer 502 abraded by the cleaning blade 81 has a high correlation with the total number of rotations or the total drive time of the photosensitive member 50 from a start of use of the image forming apparatus 1. The correlation between the abrasion amount of the photosensitive layer 502 and the total number of rotations or the total drive time can be known through an experiment or a test. The storage 90 stores information representing the correlation therein. The estimation section 111 can accordingly estimate the abrasion amount of the photosensitive layer 502 abraded by the cleaning blade 81 based on the information representing the correlation and the total number of rotations of the photosensitive member 50. For example, the storage 90 stores therein an abrasion amount of the photosensitive layer 502 per rotation of the photosensitive member 50. Alternatively, the estimation section 111 can estimate an abrasion amount of the photosensitive layer 502 abraded by the cleaning blade 81 based on the information representing the correlation and the total drive time of the photosensitive member 50. For example, the storage 90 stores therein an abrasion amount of the photosensitive layer 502 per unit time of use of the photosensitive member 50. For example, the photosensitive member 50 is abraded by 5 μm per 100-hour drive time.

The determination section 112 in the present embodiment determines, based on a result of estimation by the estimation section 111, whether or not static electricity is to be eliminated from the circumferential surface 50a of the photosensitive member 50. In the above configuration, the determination section 112 can determine whether or not static electricity is to be eliminated from the circumferential surface 50a of the photosensitive member 50 based on the precisely estimated film thickness of the photosensitive layer 502. As a result, occurrence of charging irregularity can be inhibited while more accurately reducing degradation of the circumferential surface 50a of the photosensitive member 50.

The configuration of the controller 95 will be described further in detail with further reference to FIG. 6. As illustrated in FIG. 6, the controller 95 further includes a judgement section 114. The processor of the controller 95 functions as the judgement section 114 through execution of the computer programs stored in the storage device of the storage 90.

The judgement section 114 determines whether or not the film thickness of the photosensitive layer 502 is equal to or greater than a threshold. For example, when the photosensitive member 50 of the image forming section 30 is the first photosensitive member 50 shown in Table 1, the threshold of the film thickness of the photosensitive layer 502 is 25 μm. As such, the judgement section 114 determines whether or not the film thickness of the photosensitive layer 502 of the first photosensitive member 50 is equal to or greater than 25 μm. Alternatively, for example, when the photosensitive member 50 of the image forming section 30 is the second photosensitive member 50 shown in Table 1, the threshold of the film thickness of the photosensitive layer 502 is 35 μm. As such, the judgement section 114 determines whether or not the film thickness of the photosensitive layer 502 of the second photosensitive member 50 is equal to or greater than 35 μm.

The determination section 112 in the present embodiment determines, based on a result of determination by the judgement section 114, whether or not static electricity is to be eliminated from the circumferential surface 50a of the photosensitive member 50. The first static eliminating section 61 can be turned on and off according to the threshold. In the above configuration, the photosensitive member 50 can be irradiated with static elimination light only when necessary. As a result, occurrence of charging irregularity can be inhibited while reducing degradation of the circumferential surface 50a of the photosensitive member 50.

### [Image Forming Method]

Description will be made next about an image forming method implemented by the image forming apparatus 1 according to the present embodiment. The image forming method includes charging, estimating, determining, and eliminating static electricity. In the charging, the circumferential surface 50a of the photosensitive member 50 including the photosensitive layer 502 is charged. In the estimating, a film thickness of the photosensitive layer 502 is estimated. In the determination, whether or not static electricity is to be eliminated from the circumferential surface 50a of the photosensitive member 50 is determined based on a result of estimation in the estimating. In the eliminating static electricity, static electricity is eliminated, based on determination in the determining, from the circumferential surface 50a of the photosensitive member 50 charged in the charging.

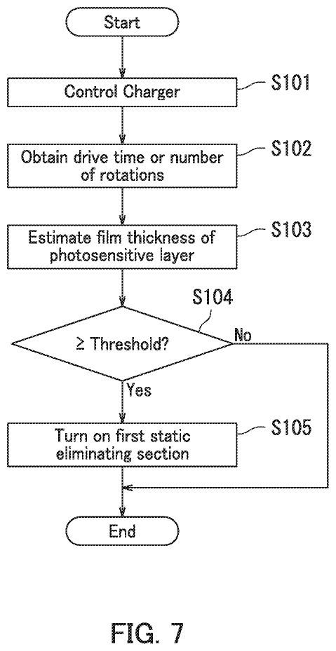

The following describes a process performed by the controller 95 in the present embodiment with reference to FIG. 7. FIG. 7 is a flowchart depicting an example of the process performed by the controller 95. The process performed by the controller 95 includes Steps S101 to S105.

In Step S101, the controller 95 controls the charger 51 so that the surface potential of the charging roller 51a is a target value. The process proceeds to Step S102.

In Step S102, the estimation section 111 acquires a total drive time or a total number of rotations of the photosensitive member 50 measured by the measurement section 113. The process proceeds to Step S103.

In Step S103, the estimation section 111 estimates a film thickness of the photosensitive layer 502 based on the total drive time or the total number of rotations of the photosensitive member 50 measured by the measurement section 113. The process proceeds to Step S104.

In Step S104, the judgement section 114 determines whether or not the film thickness of the photosensitive layer 502 estimated by the estimation section 111 is equal to or greater than the threshold. When the film thickness of the photosensitive layer 502 is smaller than the threshold (No in Step S104), the process ends. When the film thickness of the photosensitive layer 502 is equal to or greater than the threshold (Yes in Step S104), the process proceeds to Step S105.

When an affirmative determination is made in Step S104, that is, the judgement section 114 determines that the film thickness is equal to or greater than the threshold, the determination section 112 determines in Step 105 that static electricity is to be eliminated from the circumferential surface 50a of the photosensitive member 50 by the first static eliminating section 61.

The controller 95 controls the first static eliminating section 61 to eliminate static electricity from the circumferential surface 50a of the photosensitive member 50. The process then ends.

An embodiment of the present disclosure has been described so far with reference to the drawings. However, the present disclosure is not limited to the above embodiment and can be practiced in various manners within a scope not departing from the gist of the present embodiment. Elements of configuration disclosed in examples of the above embodiment can be combined as appropriate to form various disclosures. For example, some elements of configuration described in the embodiment may be omitted. Alternatively or additionally, some of elements of configuration in different examples of the embodiment may be combined as appropriate. The drawings schematically illustrate main elements of configuration in order to facilitate understanding. Aspects such as thickness, length, and number of the elements of configuration illustrated in the drawings may differ from actual ones for convenience in preparation of the drawings. Furthermore, properties of the elements of configuration described in the above embodiment, such as speed, material, shape, and dimension, are merely examples and are not intended as specific limitations. Various alterations may be made so long as there is no substantial deviation from the effects of the present disclosure.

The charging rollers 51a have been described each as an example of the charger arranged in contact with the circumferential surface 50a of the photosensitive member 50. However, the charger may be a charging brush. Although a configuration in which the charging voltage is a direct current voltage has been described, the present disclosure is also applicable to a configuration in which the charging voltage is an alternating current voltage or a composite voltage. The composite voltage is a voltage obtained by superimposing a direct current voltage on an alternating current voltage. Although the development rollers 52 each using a two-component developer containing the carrier CA and the toner T have been described, the present disclosure is also applicable to development devices each using a one-component developer. Although the image forming apparatus 1 adopting an intermediate transfer process has been described, the present disclosure is also applicable to an image forming apparatus adopting a direct transfer process.

What is claimed is:

1. An image forming apparatus comprising:
an image bearing member that includes a photosensitive layer;
a charger configured to charge a circumferential surface of the image bearing member;
a first static eliminating section configured to eliminate static electricity from the charged circumferential surface of the image bearing member; and
a determination section configured to determine, based on a thickness of the photosensitive layer, whether or not static electricity is to be eliminated from the circumferential surface of the image bearing member.

2. The image forming apparatus according to claim 1, further comprising:
a measurement section configured to measure a total drive time or a total number of rotations of the image bearing member from a start of use of the image forming apparatus; and
an estimation section configured to estimate the thickness of the photosensitive layer based on a result of measurement by the measurement section, wherein
the determination section determines, based on a result of estimation by the estimation section, whether or not static electricity is to be eliminated from the circumferential surface of the image bearing member.

3. The image forming apparatus according to claim 1, further comprising
a judgement section configured to determine whether or not the thickness of the photosensitive layer is equal to or greater than a threshold, wherein
the determination section determines, based on a result of determination by the judgement section, whether or not static electricity is to be eliminated from the circumferential surface of the image bearing member.

4. The image forming apparatus according to claim 1, further comprising
a cleaning section configured to collect residual toner remaining on the circumferential surface of the image bearing member, wherein
the first static eliminating section eliminates static electricity from a portion of the image bearing member located between the charger and the cleaning section.

5. The image forming apparatus according to claim 4, further comprising:
a light exposure section configured to expose to light the circumferential surface of the image bearing member after charging by the charger to form an electrostatic latent image on the circumferential surface of the image bearing member;
a developing section configured to develop the electrostatic latent image with toner to form a toner image on the circumferential surface of the image bearing member;
a transfer section configured to transfer the toner image to a transfer target; and
a second static eliminating section configured to eliminate static electricity from the circumferential surface of the image bearing member after transfer of the toner image by the transfer section, wherein
the second static eliminating section is disposed on an upstream side of the cleaning section in a rotational direction of the image bearing member, and
the cleaning section collects the residual toner remaining on the circumferential surface of the image bearing member after the second static eliminating section eliminates static electricity from the circumferential surface of the image bearing member.

6. The image forming apparatus according to claim 5, further comprising
a third static eliminating section configured to eliminate static electricity from the circumferential surface of the image bearing member after development of the electrostatic latent image by the developing section and before transfer of the toner image by the transfer section.

7. The image forming apparatus according to claim 1, wherein
the image bearing member includes a conductive substrate and a photosensitive layer,
the photosensitive layer is a single layer, and
the photosensitive layer contains a charge generating material, a hole transport material, an electron transport material, and a binder resin.

8. An image forming method comprising:
charging a circumferential surface of an image bearing member that includes a photosensitive layer;
determining whether or not static electricity is to be eliminated from the circumferential surface of the image bearing member based on a thickness of the photosensitive layer; and
eliminating static electricity from the charged circumferential surface of the image bearing member based on a result of determination in the determining.
